(19) United States
(12) Patent Application Publication
(10) Pub. No.: US 2017/0324893 A1
(43) Pub. Date: Nov. 9, 2017

(54) NETWORK SYSTEM AND CONTROL METHOD FOR NETWORK SYSTEM

(71) Applicant: CANON KABUSHIKI KAISHA, Tokyo (JP)

(72) Inventor: Kotaro Matsuda, Kawasaki-shi (JP)

(21) Appl. No.: 15/497,976

(22) Filed: Apr. 26, 2017

(30) Foreign Application Priority Data
May 6, 2016 (JP) 2016-092940

(51) Int. Cl. H04N 5/232; H04N 21/4223; H04N 21/414; H04N 21/488; H04N 7/18

(52) U.S. Cl. CPC H04N 5/23206; H04N 21/4882; H04N 21/4223; H04N 21/41407; H04N 7/181; H04N 5/23216; H04N 5/23293; H04N 5/23229; H04N 5/23222; H04N 5/23296

(57) ABSTRACT

Provided is a network system that comprises a camera provided at a predetermined shooting point, a camera system for providing a shooting service by the camera, and an information processing apparatus carried by a user. In the network system, a notification of a confirmation for shooting is provided to the information processing apparatus detected in a shooting area of the camera in accordance with a movement of the user, and a camera control right is controlled. If an instruction for an operation of the camera is inputted on the information processing apparatus in accordance with an acquisition of the camera control right, an image shot by the camera following the inputted instruction is provided to the information processing apparatus through the camera system.

### BACKGROUND OF THE INVENTION

### Field of the Invention

The present invention relates to a network system, and a control method for the network system.

### Description of the Related Art

Recently, the market of network cameras is increasing. The most part is a network camera for enterprises, which is installed for security. In contrast, a product of a network camera or a web camera for personal use, which is inexpensive and simple, is beginning to appear on the market. These products can be remotely operated easily and shoot easily from a mobile terminal such as a tablet, smart phone, or the like by an ad-hoc connection to a wireless LAN or the like. The use or the purpose of the network camera is expected to expand to other fields such as leisure, entertainment, or the like from the security field.

Japanese Patent Laid-Open No. 2004-40736 discloses an image information transmitting and receiving system that, when a visitor comes to a suitable place for shooting a commemorative photograph at an exhibition hall, such as a museum, or a theme park, takes a photograph of the visitor and provides the image to the visitor. In Japanese Patent Laid-Open No. 2004-40736, it is disclosed that, when the visitor carrying an image information receiving device comes to the shooting point selected in advance, a shooting image transmitting device displays an image of the shooting point and if the visitor remotely operates the image transmitting device, image information is provided to the visitor.

Further, due to the prevalence of a mobile terminal such as a smart phone and the increasing performance of a camera mounted thereon, opportunities for a user to shoot a photograph by the mobile terminal are increasing. In addition, a user of the mobile terminal often takes a “selfie”, which is taking a photograph of oneself including the background, especially at a tourist spot or a leisure facility. When taking selfies, there is a user that uses equipment called selfie-stick and moves a smart phone to a position far from oneself to shoot so that the background may be more widely photographed.

However, using selfie-stick diverts the user's attention from the surroundings, using selfie-stick frequently causes problems such as bothering surrounding people, destroying surrounding objects, getting the user itself into danger such as falling down, or the like. Therefore, recently, there is a movement to forbid bringing and using the selfie-stick at a museum, art museum, theme park, event site, or the like.

In addition, taking selfies using a smart phone has a limit in angle of view even using selfie-stick so that shooting a photograph of yourself including a broad background is difficult. The method disclosed in Japanese Patent Laid-Open No. 2004-40736 can only perform an operation of a camera having poor flexibility such as guiding a user to a fixed facility like a picture spot and taking a photograph of the user in turn.

### SUMMARY OF THE INVENTION

The present invention provides a network system that is able to perform shooting easily by using a network camera.

According to an aspect of the present invention, a network system that includes a camera provided at a predetermined shooting point, a camera system for providing a shooting service by the camera, and an information processing apparatus carried by a user is provided. The system comprises: a notification unit configured to provide a notification of a confirmation for shooting to the information processing apparatus detected in a shooting area of the camera in accordance with a movement of the user; a control unit configured to control a camera control right; an instruction unit configured to input an instruction for an operation of the camera on the information processing apparatus in accordance with an acquisition of the camera control right; and a providing unit configured to provide an image shot by the camera following the inputted instruction to the information processing apparatus through the camera system.

Further features of the present invention will become apparent from the following description of exemplary embodiments with reference to the attached drawings.

### BRIEF DESCRIPTION OF THE DRAWINGS

FIG. 1 is a diagram illustrating a system configuration according to an embodiment of the present invention.

FIG. 2 is a diagram illustrating a module configuration of each apparatus according to an embodiment of the present invention.

FIG. 3 is a diagram illustrating a software configuration of the present system.

FIG. 4 is a diagram illustrating an example of a geographic location of a network camera.

FIG. 5 is a diagram illustrating a location of a network camera and a beacon transmitter.

FIG. 6 is a diagram illustrating a relationship between a property of a beacon and a setting of a network camera.

FIG. 7 is a diagram illustrating a relationship between a property of a beacon and a setting of a network camera.

FIGS. 8A to 8D are diagrams illustrating user interfaces for an application.

FIGS. 9A to 9C are diagrams illustrating user interfaces for an application.

FIG. 10 is a flowchart illustrating a method for providing a selfie shooting service.

FIG. 11 is a flowchart illustrating a method for providing a selfie shooting service.

FIGS. 12A and 12B are diagrams illustrating an example of a screen for confirming a preview image.

FIG. 13 is a flowchart illustrating a method for performing an option process for privacy protection.

FIG. 14 is a flowchart illustrating a method for performing an option process for the identification of a person.

FIG. 15 is a flowchart illustrating a method for performing an option process for restricting a video distribution.

### DESCRIPTION OF THE EMBODIMENTS

Hereinafter, embodiments of the present invention will be described with reference to the drawings.

### First Embodiment

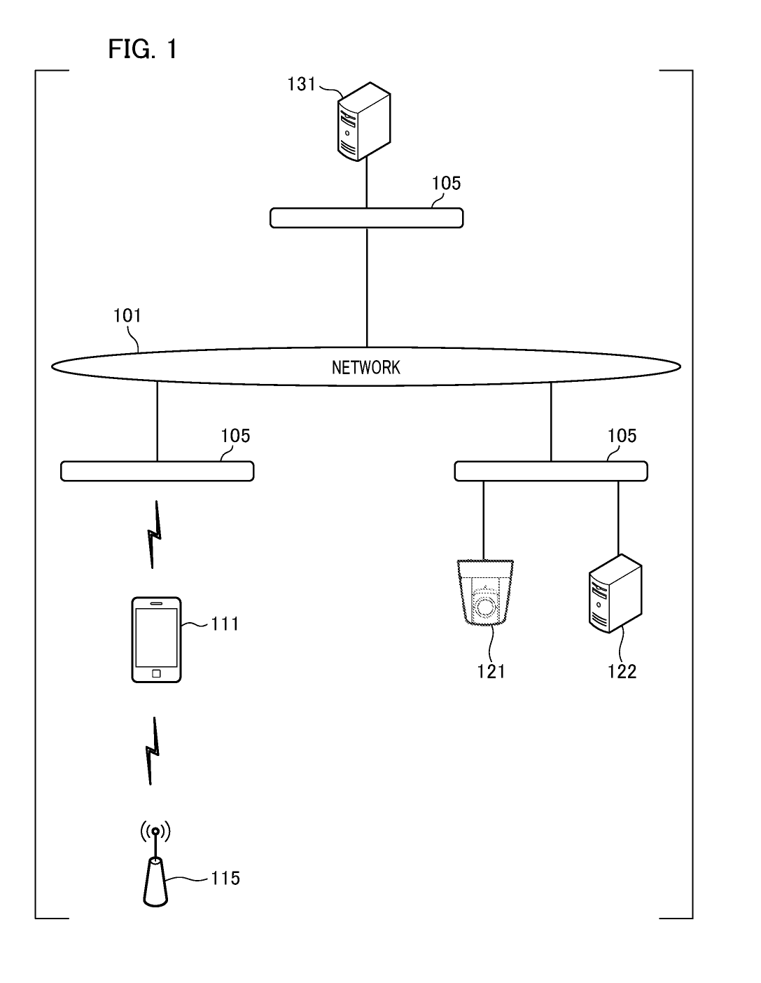

FIG. 1 is a diagram illustrating an example of a system configuration and a network configuration according to an embodiment of the present invention.

The system according to an embodiment of the present invention is a network system that includes a network camera 121 provided at a predetermined shooting point, a camera system for providing a shooting service by the network camera 121, and an information processing apparatus which is carried by a user and serves as a client computer.

A network 101 is a network such as the internet, an intranet, or the like. LAN (Local Area Network) 105 is an end of the network to which an apparatus such as a computer or the like is connected. The LAN 105 is not limited to a wired communication network but also may be a wireless communication network such as a wireless LAN, mobile phone communication network, or the like.

A client computer 111 includes types such as personal computer, tablet computer, smart phone and the like. A beacon transmitter 115, which is a location information transmitter, can transmit and receive information by wireless communication with the client computer 111 which includes a beacon receiving function. For example, the beacon transmitter 115 may have a beacon transmitting and receiving function using a wireless communication standard called BLE (Bluetooth Low Energy). Bluetooth is a registered trademark. Unlike the GPS (Global Positioning System), beacon can easily detect locally in a neighboring area.

The network camera 121 includes some types based on the difference of a lens or operation mechanism such as fixed box, PTZ, wide-angle, or the like. A camera control server 122 and a camera management server 131 may be configured in a same server or in separate servers. The camera control server 122 and the camera management server 131 are collectively called a camera system. The number of configurations in the camera system is not limited.

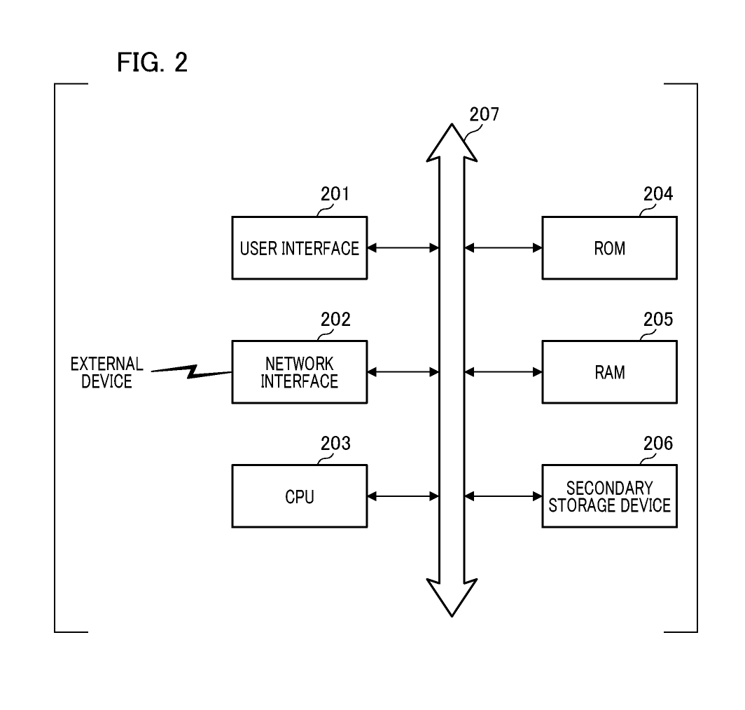

FIG. 2 is a diagram illustrating a module configuration of an information processing function for a client computer 111, a network camera 121, a camera control server 122, and a camera management server 131. A user interface 201 inputs and outputs information by using a display, a keyboard, a mouse, a touch panel, or the like. A computer that does not include this hardware can be connected or operated by other computers by using a remote desktop, a remote shell, or the like.

A network interface 202 connects to a network such as a LAN or the like and communicates with other computers or network apparatuses. In a ROM 204, an embedded program or data is recorded. A RAM 205 is a temporary memory area. A secondary storage device 206 is a secondary storage device as typified by a HDD. A CPU 203 executes a program read from the ROM 204, the RAM 205, the secondary storage device 206, or the like. Each unit is connected via an input-output interface 207.

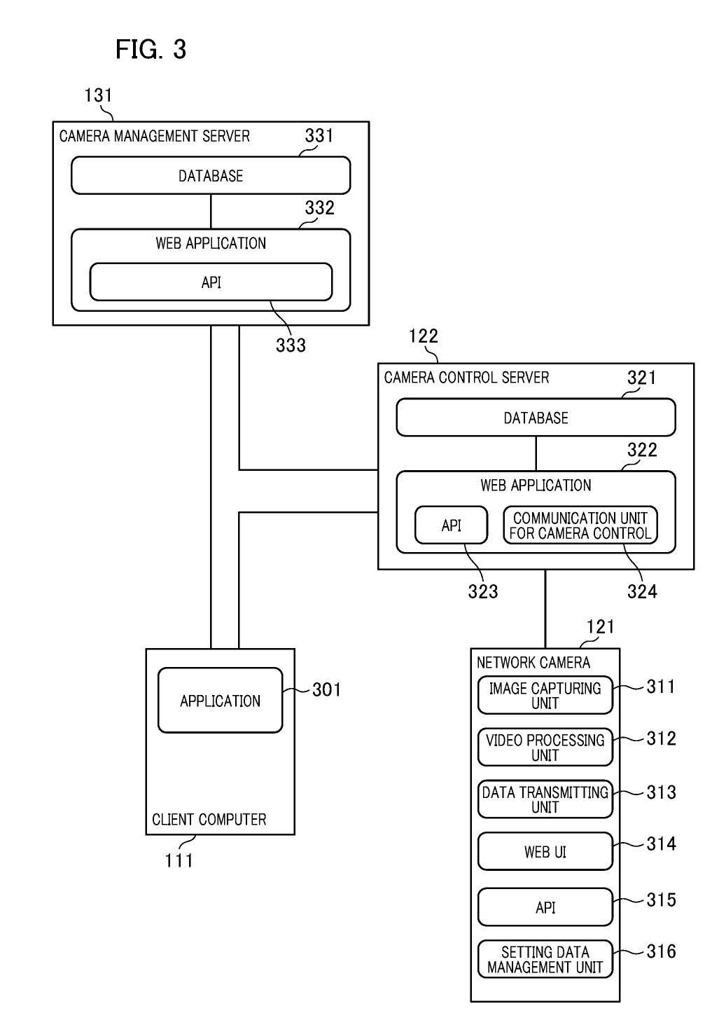

FIG. 3 is a diagram illustrating a software configuration and an interconnection status of the present system.

The client computer 111 includes an application 301. The application 301 is installed and executed on the client computer 111. The application 301 detects entering or leaving the area of a beacon from the beacon transmitter 115, and communicates with the camera management server 131 and the camera control server 122 for providing a function for taking selfies by the network camera 121.

The network camera 121 includes an image capturing unit 311, a video processing unit 312, a data transmitting unit 313, a Web UI 314, an API 315, and a setting data management unit 316. The image capturing unit 311 is an image capturing unit of the network camera 121 and controls a lens or an image sensor of the camera and acquires an image. The video processing unit 312 applies processing to an original image acquired by the image capturing unit 311 and processing to video data. In addition, the video processing unit 312 performs additional processing such as image recognition, and acquires additional information from the image or the video.

The data transmitting unit 313 transmits the video data to other apparatuses on a network. The Web UI 314 provides a viewer screen or a management screen of the network camera 121. In the viewer screen, a video that the camera has captured can be confirmed and an operation on the camera such as a direction, a zoom, or a focus of the camera, or the like can be performed.

In the management screen, a preset registration for the image capturing position of the camera, instruction for the processing to be applied by the video processing unit 312, a destination registration of the video data to be transmitted by the data transmitting unit 313, or the like can be performed. The API 315 performs operation of the camera, a setting data registration, or the like by a request from other apparatuses. The setting data management unit 316 holds setting data for the capturing unit 311, video processing unit 312, and the data transmitting unit 313.

The camera control server 122 includes a database 321 and a Web application 322. The database 321 is a database included in the camera control server 122 and holds data necessary for each function of the camera control server. The Web application 322 provides an application programming interface (hereinafter referred to as an API) 323 and a communication unit for camera control 324.

The Web application 322 processes a request from other apparatuses, and if necessary, accesses data of the database 321, performs various functions, and returns a response through a network. The API 323 processes a request from the application 301, performs control of the network camera 121 from the communication unit for camera control 324, and returns a response.

The camera management server 131 includes a database 331 and a Web application 322. The database 331 is a database included in the camera management server 131 and holds data necessary for each function of the camera management server. The Web application 322 provides an API 333.

The Web application 332 processes a request from other apparatuses, and if necessary, accesses data of the database 331, performs various functions, and returns a response through a network. The API 333 receives a request from the application 301, performs various processing, and returns a response.

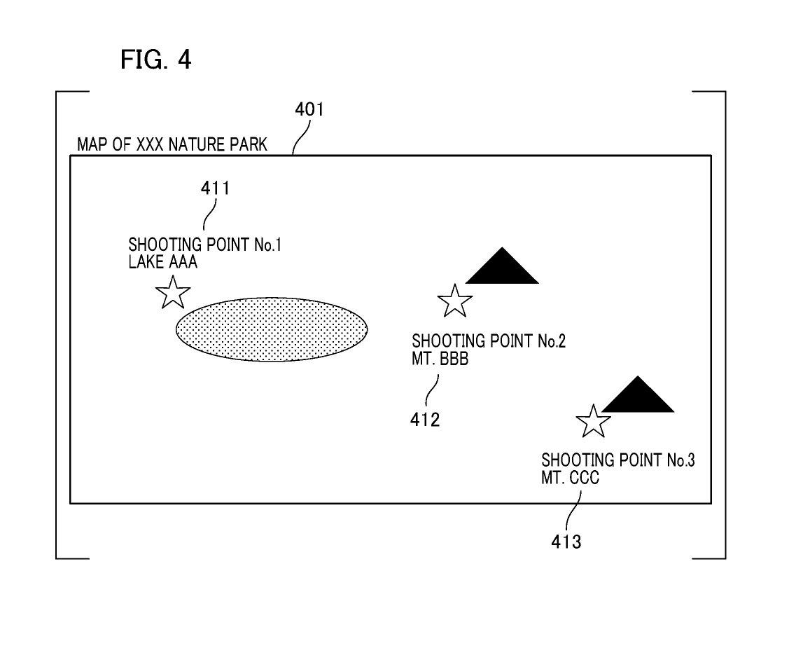

FIG. 4 is a diagram illustrating an example of a geographic location of the network camera 121 according to the present embodiment.

For example, in the area called XXX nature park, assume that a plurality of shooting points are provided. A reference numeral 401 is a map of the XXX nature park. A shooting point 411 is a shooting point provided at lake AAA. A shooting point 412 is a shooting point provided at mountain BBB. A shooting point 413 is a shooting point provided at mountain CCC.

In order to enable a user to select a shooting place relatively freely in such parks or outdoors, it is suitable to use a PTZ (Pan, Tilt, Zoom) network camera having a PTZ (Pan, Tilt, Zoom) control type, which can flexibly change a shooting area. In order to shoot by the network camera having PTZ control type from the mobile terminal or the like, a complicated procedure such as obtaining a URL of the camera in advance, acquiring camera control right, or putting an intended target into the shooting frame by the position adjustment by the PTZ, or the like is required. However, in the present embodiment, by using the beacon transmitting and receiving function and a push notification function of the client computer, the network camera can be used easily.

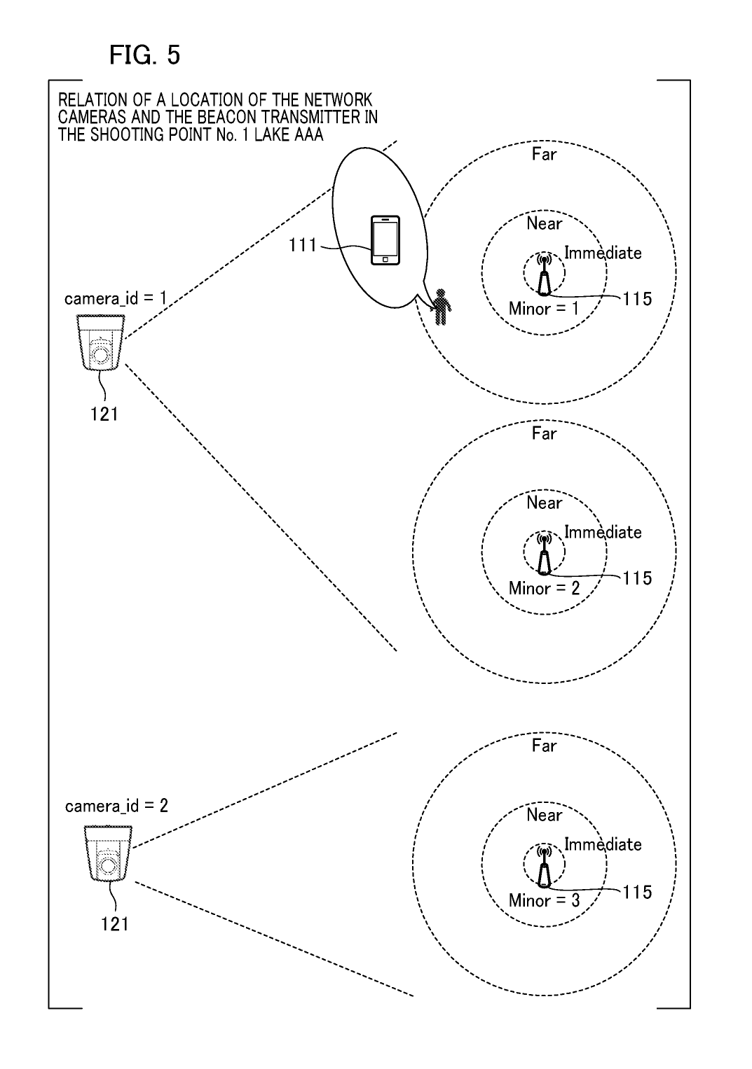

FIG. 5 is a diagram illustrating the relations between a location of a plurality of the network cameras 121 and a plurality of the beacon transmitters 115 in the shooting point 411.

The network camera 121 is given a camera_id for identifying each camera. According to a standard specification of the beacon, in data included in a signal transmitted by the beacon transmitter, properties called “proximityUUID”, “major”, and “minor”, which are for identifying the beacon transmitter, are stored.

By using these properties, an area which can be shot by the network camera 121 is identified. An example of mapping data of the properties of the beacon and the network cameras which are able to shoot is described below in JSON (JavaScript Object Notation) format. JavaScript is a registered trademark.

```
{
  ″proximityUUID″: ″b9442b50-142e-466b-ba9e-ff1861604b01″,
  ″description_en″: ″Selfie Shooting Service″,
  ″description_ja″: ″Selfie Shooting Service″,
  ″major″: [
    {
      ″major″: ″1″,
      ″description_en″: ″Shooting Point No.1 Lake AAA″,
      ″description_ja″: ″Shooting Point No.1 Lake AAA ″,
      ″minor″: [
        {
          ″minor″: ″1″,
          ″camera_id″: ″1″,
          ″proximity″: [
            {
              ″proximity″: ″Far″,
              ″camera_preset_number″: ″1″,
            },
            {
              ″proximity″: ″Near″,
              ″camera_preset_number″: ″2″,
            },
            {
              ″proximity″: ″Immediate″,
              ″camera_preset_number″: ″3″,
            }
          ]
        },
        {
          ″minor″: ″2″,
          ″camera_id″: ″1″,
          ″proximity″: [ ]
        },
        {
          ″minor″: ″3″,
          ″camera_id″: ″2″,
          ″proximity″: [ ]
        }
      ]
    },
    {
      ″major″: ″2″,
      ″description_en″: ″Shooting Point No.2 Mt. BBB″,
      ″description_ja″: ″Shooting Point No.2 Mt. BBB ″,
      ″minor″: [
        {
          ″minor″: ″1″,
        }
      ]
    },
    {
      ″major″: ″3″,
      ″description_en″: ″Shooting Point No.3 Mt. CCC″,
      ″description_ja″: ″Shooting Point No.3 Mt. CCC ″,
      ″minor″: [
        {
          ″minor″: ″1″,
        }
      ]
    }
  ]
}
```

A description will be given of the data in the JSON format described above. Firstly, whether a beacon is for the selfie shooting service can be identified by the proximityUUID. Which shooting point it is among the shooting points 411 to 413 can be identified by the major property.

Which beacon transmitter it is among the beacons in a shooting point can be identified by the minor property. Further, when the beacon is received, a proximity property (Far, Near, Immediate) indicating a distance between the beacon transmitter can be acquired. If the client computer 111 enters the area of the beacon transmitter 115, an approximate location of your own machine can be identified by these properties of the beacon.

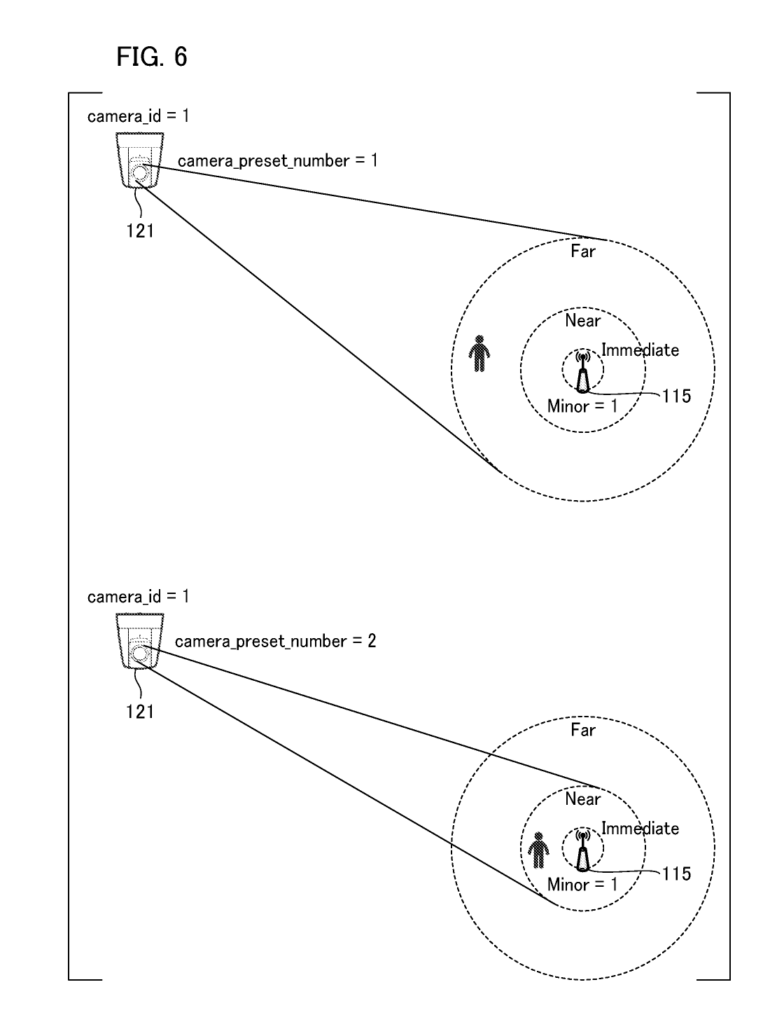

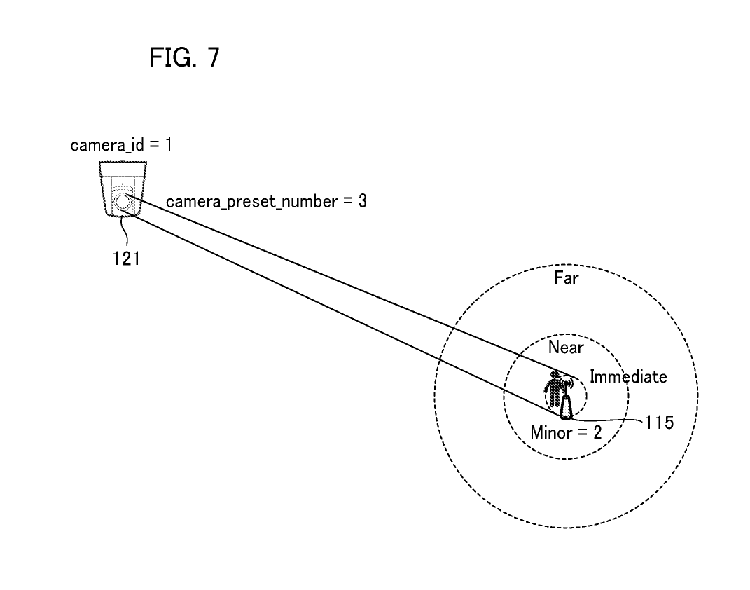

FIGS. 6 and 7 are diagrams illustrating a relationship between angle of view and zoom setting of the network camera 121, which correspond to the proximity property of the beacon.

When the proximity properties of the beacon are Far, Near, and Immediate, 1, 2, and 3 are used as a preset number (camera_preset_number) of the network camera 121, respectively, and a direction and a zoom of the camera is adjusted using them.

Due to holding the camera_preset_number in each of the proximity properties in the data in JSON format described above, which preset number to use is determined according to the location of the client computer 111. In addition, due to holding the camera_id of the camera which is able to shoot for each number of the minor in the data in JSON format described above, which camera is able to shoot is determined in each area of the beacon.

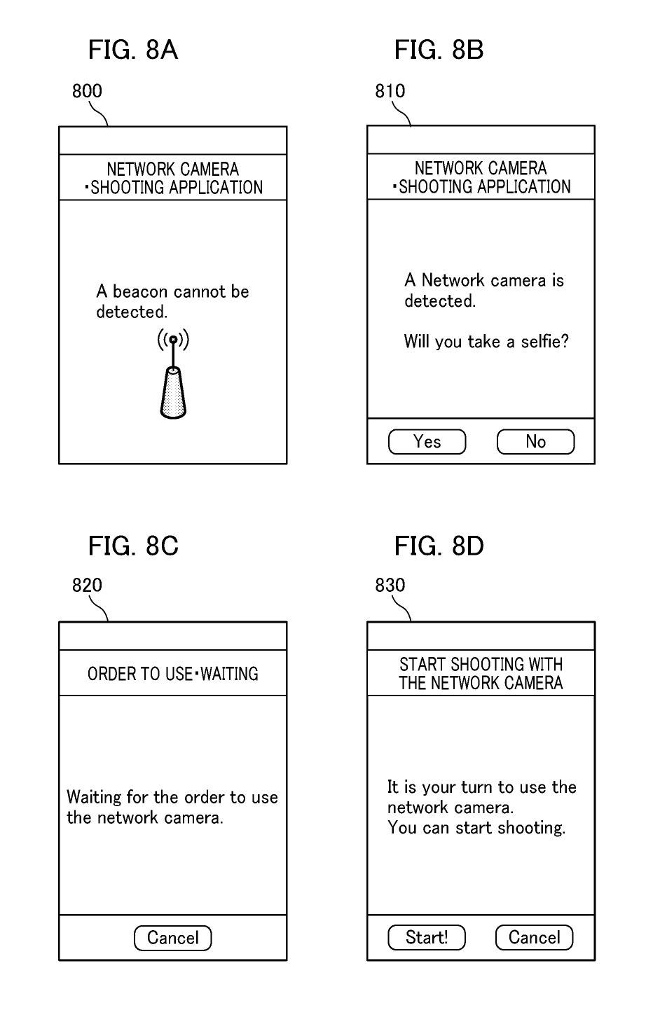

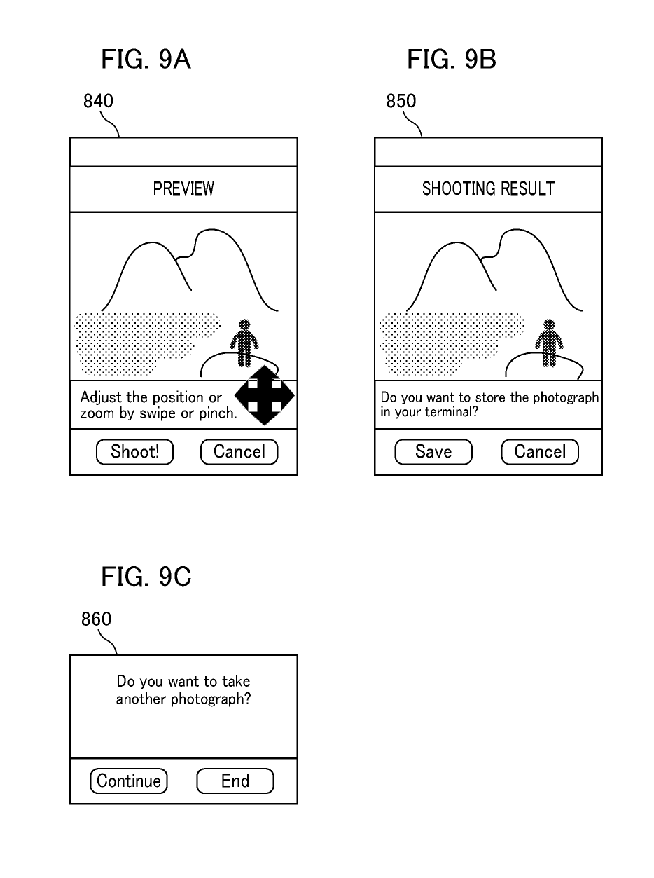

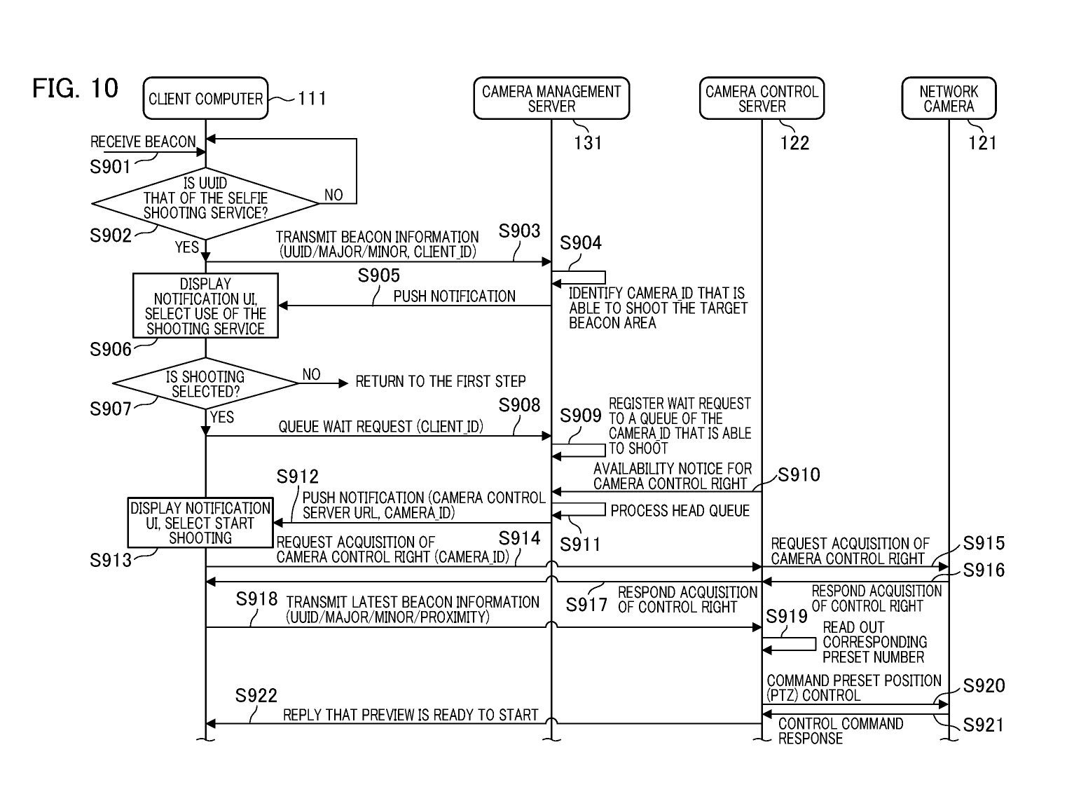

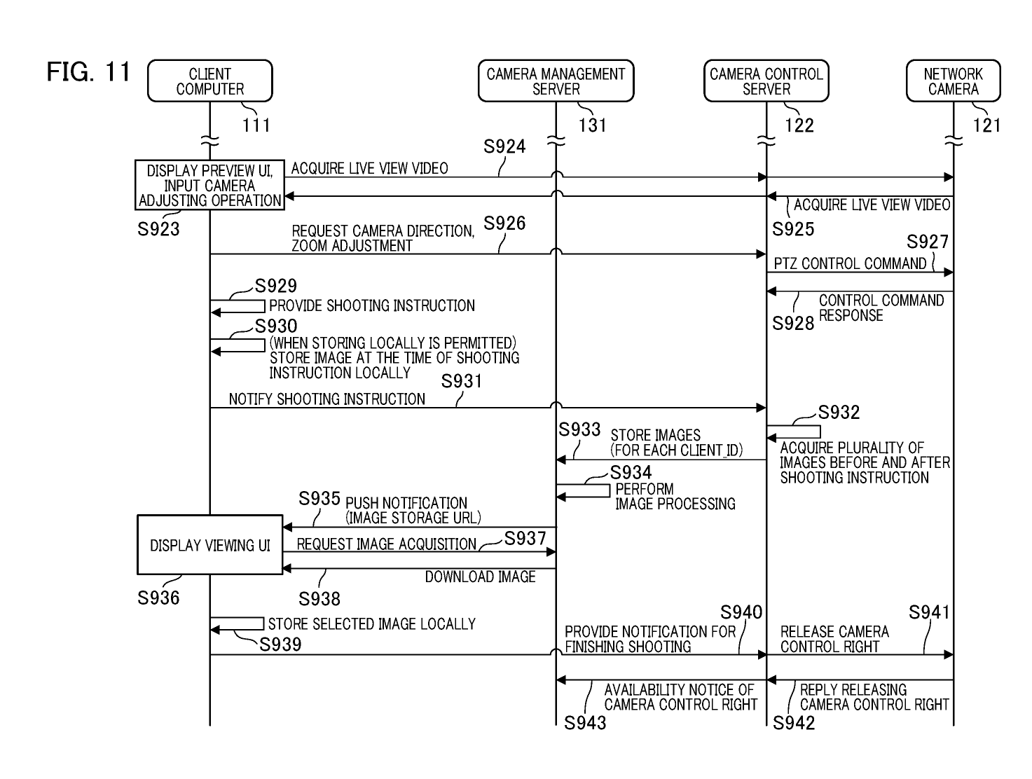

FIGS. 8A to 8D and FIGS. 9A to 9C are diagrams illustrating user interface(s) (hereinafter referred to as UI(s)) of the application 301 of the client computer 111. In addition, FIG. 10 and FIG. 11 are flowcharts illustrating a method for providing the application 301 of the client computer 111 with a selfie shooting service by the camera management server 131, camera control server 122, and the network camera 121. Hereinafter, a description will be given of the selfie shooting service by referring to FIGS. 8A to 8D, FIGS. 9A to 9C, FIG. 10 and FIG. 11.

Note that the selfie shooting service is a service in which a user performs shooting using a network camera with an intended angle of view and zoom magnification, and is not a service for only taking “selfie(s)”. Due to using the selfie shooting service, a system can be proposed for diverting some video cameras installed at a tourist spot or the like for surveillance to a shooting camera for tourist in some time zones or the like.

For example, a shooting from an angle that a tourist can never shoot becomes possible. Due to adding a billing system by this service, profits that cannot be obtained only by the operation of the surveillance camera may be generated and thereby increasing the installations of cameras, benefits can be enjoyed such as improvement of security as a result.

A screen 800 is an initial screen of the application 301 and indicates a state in which the client computer 11 is not receiving a beacon of which the proximityUUID property indicates that the beacon is for the selfie shooting service. If the client computer 111 receives a beacon from the beacon transmitter 115 (S901) in accordance with a movement of the user, the application 301 confirms the proximityUUID property of the received beacon. Then, the application 301 determines whether the beacon is for the selfie shooting service (S902).

If the application 301 determines that the beacon is for the selfie shooting service, the application 301 transmits the property of the beacon and the client_id to the camera management server 131 (S903). The client_id is a unique ID for identifying each instance of the application 301. The camera management server 131 refers to mapping data of properties of the beacon and network cameras which are able to shoot, as data described above in JSON format.

The camera management server 131 identifies the network camera 121 (camera_id) that is able to shoot the area of the beacon identified by the proximityUUID/major/minor (the network camera 121 for which the shooting area is in the area of the beacon identified by the proximityUUID/major/minor) (S904). The camera management server 131 performs push notification in which the network camera 121 for the selfie shooting service is available to the application 301 of the client computer 111, which is identified by the client_id.

The client computer 111 displays a screen 810 on the UI of the application 301 to make the user select whether to use the selfie shooting service or not (S906). The application 301 determines a selection result on the screen 810. If using the selfie shooting service is selected, the client computer 111 transmits a wait request to the camera management server 131 (S908). Further, the client computer 111 displays a screen 820 on the UI of the application 301 to inform the user that the client computer 111 is waiting for the order to use. The camera management server 131 registers the wait request to a queue of the aforementioned camera_id that is able to shoot (S909). An example of data of the queue is described below in JSON format.

```
{
  ″cameras″: [
    {
      ″camera_id″: ″1″,
      ″queue″: [
        {
          ″request_time″: ″2015-11-10T15:23:35.979″,
          ″client_id″:
″c8f8c6c8-e98d-4bce-aa16-c065002a5372″
        },
        {
          ″request_time″: ″2015-11-10T15:25:44.032″,
          ″client_id″:
3d36198d-d938-41f7-b267-39e7f8ae37f8″
        }
      ]
    },
    {
      ″camera_id″: ″2″,
      ″queue″: [ ]
    }
  ]
}
```

In each camera_id, a receiving date of the wait request and a client id for identifying the transmission source application are held in the queue as data. When a use of the network camera 121 is finished, the camera control server 122 transmits an availability notice of the camera control right to the camera management server 131 (S910). The camera management server 131 processes the head of the queue of the wait request (S911).

The camera management server 131 performs a push notification to perform notification that the camera is ready to be used to the application 301 that is identified by the client_id included in the head queue and is waiting for the order to use (S912). At that time, a communication destination URL of the camera control server 122 and the camera_id that is ready to be used are notified. The client computer 111 displays a screen 830 on the UI of the application 301 and receives a selection (input) to start shooting (S913).

If start shooting is selected, the client computer 111 transmits an acquisition request for the camera control right, in which the camera_id is specified, to the control server 122 (S914). The camera control server 122 transmits the acquisition request for the camera control right to a network camera 121 that corresponds to the camera_id specified in the acquisition request and acquires the camera control right (S915, S916).

The camera control server 122 replies to the client computer 111 that it was able to acquire the camera control right (S917). The client computer 111 transmits the properties of the latest beacon that indicates the location of the client computer 111 itself (S918). The camera control server 122 refers to the mapping data of the received properties of the beacon and the network camera that is able to shoot, and acquires a preset number that corresponds to the transmitted proximity property (S919).

The camera control server 122 specifies the acquired preset number to transmit a command for controlling a direction and a zoom of the camera to the network camera 121 (S920). The network camera 121 returns a response if changing the direction and the zoom of the camera to a preset position that corresponds to the present number has finished (S921). The camera control server 122 replies to the client computer 111 that a preview (live view) of a video of the network camera 121 is ready to start (S922).

The client computer 111 displays a screen 840 on the UI of the application 301 (S923). The client computer 111 requests of the camera control server 122 to acquire live view video of the network camera 121 (S924). The client computer 111 receives the live view video of the network camera 121 through the camera control server 122, and displays the live view video on the screen 840 (S925).

The client computer 111 accepts an input for adjusting the direction and the zoom of the camera on the screen 840 of the application 301. The user can adjust the direction or the zoom of the camera by an operation on the screen 840, such as a swipe operation, a pinch operation or the like. The client computer 111 transmits an adjustment request for the direction and the zoom of the camera along with those input amounts (S926). The camera control server 122 converts the received input amount to an adjustment amount of the direction and the zoom of the camera, and transmits a control command for the direction and zoom (PTZ) to the network camera 121 (S927). As described above, in the present embodiment, a network camera can be remotely operated by a mobile terminal such as a smartphone or the like to shoot with a preferable angle of view or zoom magnification.

The network camera 121 replies to the camera control server 122 when the position adjustment of the camera by PTZ control has finished (S928). Due to the client computer 111 that is continuing to display the live view video on the screen 840, the user can perform final adjustment of the direction and the zoom of the camera while checking the live view video. The client computer 111 accepts an input for shooting instruction on the screen 840 of the application 301 (S929).

The client computer 111 displays a screen 850 if storing the shot image locally is permitted, and stores the image at the time of the shooting instruction on the client computer 111 itself (S930). If storing the shooting image locally is not permitted, in step S930, the client computer 111 does not store the image on the client computer 111 itself and acquires the image through the camera system by the following process. The client computer 111 provides notification of the shooting instruction to the camera control server 122 (S931).

The camera control server 122 acquires a plurality of images that are images from before the shooting instruction to after the shooting instruction from the video received from the network camera 121 following the shooting instruction (S932). Here, a plurality of images are acquired to take into consideration a time deviation between the client computer 111 and the camera control server 122, or a case when a timing in which a user has input the shooting instruction cannot be detected accurately due to a network delay. The camera control server 122 transmits and stores the acquired images to the camera management server 131 (S933).

The camera management server 131 divides an area for storing images for each client_id, and stores the images transmitted from a plurality of camera control servers 122. The camera management server 131, if necessary, performs processing on the received image (S934). As image processing, processing according to a use such as quality improvement by a photo retouching, an overlay of a logo of a tourist spot, or the like, may be added.

When the image processing has finished, the camera management server 131 performs push notification that an image can be downloaded together with an image storage URL to the application 301 of the client computer (S935). The client computer 111 displays a screen 850 on the application 301 (S936).

The client computer 111 downloads and displays the image from the image storage URL (S937, S938), and accepts a selection of storing the image in the client computer 111 itself. At this time, the aforementioned plurality of images can be displayed for only storing the preferable image in the client computer 111 itself. If storing the images in the client computer 111 itself is selected, the client computer 111 stores the selected image to the client computer 111 itself (S939). The client computer 111 displays a screen 860 and accepts a selection about whether to continue or finish shooting.

If finishing the shooting is selected, the client computer 111 provides notification that the shooting has finished to the camera control server 122 and finishes the session of the present shooting (S940). The camera control server 122 notifies the network camera 121 (S941) about the release from the camera control right. The network camera 122 replies that the control right has been released (S942). The camera control server 122 transmits an availability notice about the camera control right to the camera management server 131 (S943).

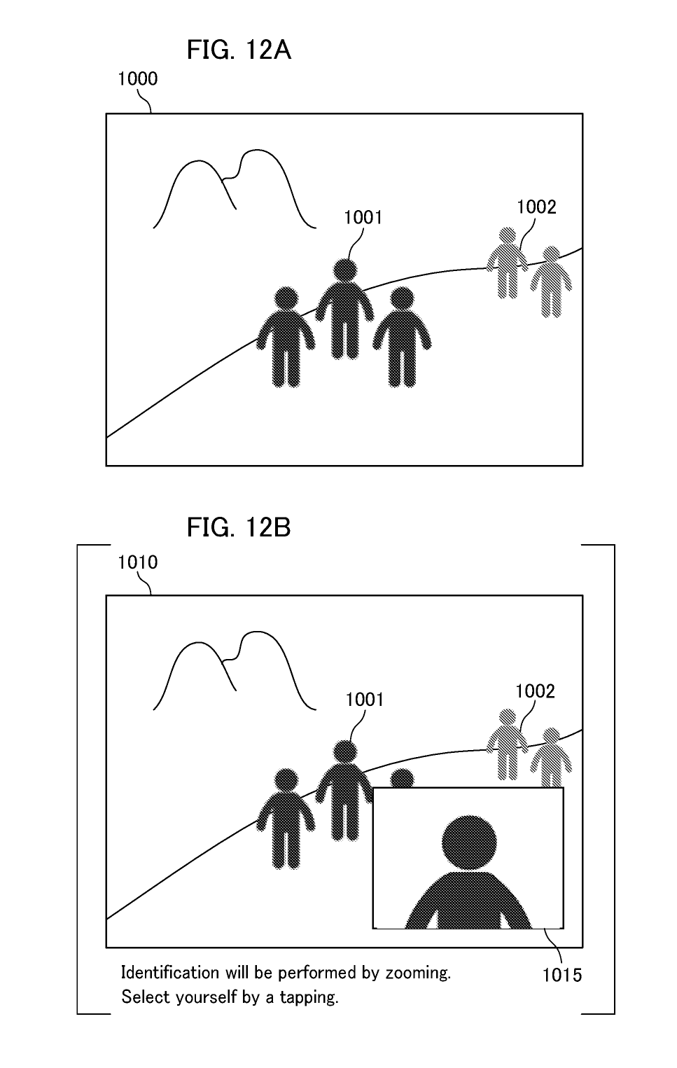

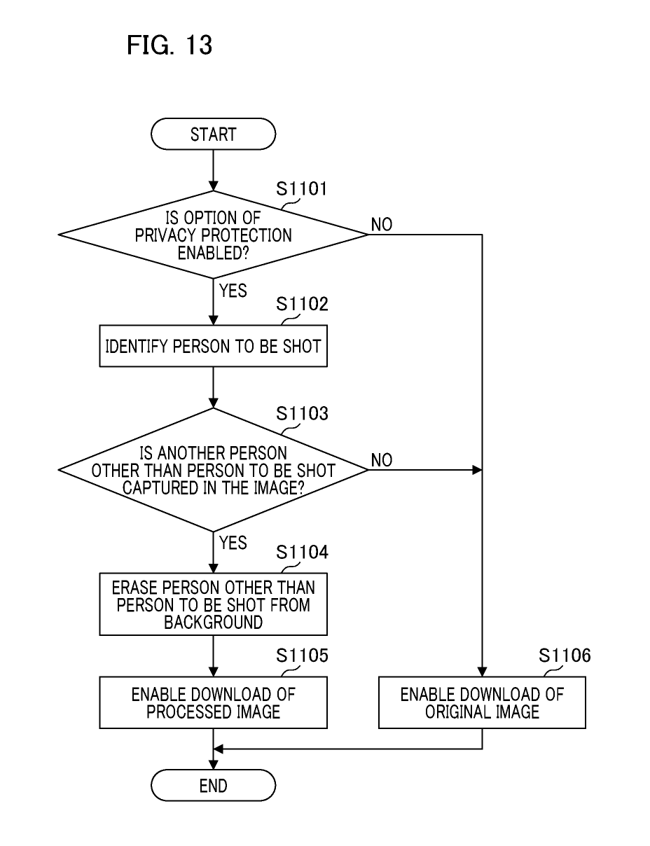

Next, a description will be given of an option process at the time of the shooting with reference to FIGS. 12A and 12B, and FIG. 13. More specifically, a description will be given of a method to provide privacy protection for a person other than a person to be photographed as the option process.

FIGS. 12A and 12B are diagrams illustrating an example of a screen for confirming a preview image at the time of the shooting. FIG. 13 is a flowchart illustrating a method for performing an option process of privacy protection at the time of the shooting.

For example, as a shooting frame 1000, assume that there are a user that operates a camera and one or more people to be photographed 1001 in a shooting frame. In addition, assume that there is a person other than the person to be photographed captured in the shooting frame as a person 1002. At this time, the option process for privacy protection for a person other than a person to be photographed is provided by the following method.

Firstly, in the aforementioned step S930, if the option of privacy protection is enabled, a shot image is not permitted to be stored locally. Further, in step S934, when the camera management server 131 performs image processing, a process shown in FIG. 13 is additionally performed.

The camera management server 131 determines whether the option of privacy protection is enabled (S1101). If it is determined that the option of privacy protection is enabled, the camera management server 131 identifies the person 1001, which is a person to be photographed, in the shooting frame 1000 (S1102). As a method for identifying the person to be photographed, there are various methods such as identifying from a focus position, making the user select, or the like, but it may be identified in any method. Further, an option process for the identification of a person described below may be additionally performed for identifying the person to be photographed (the person himself).

Next, whether other person other than the identified person to be photographed is captured in the shooting frame 1000 is determined (S1103). If it is determined that a person other than the identified person to be photographed is captured, the camera management server 131 performs image processing to erase the person other than the person to be photographed from a background (S1104). Then the camera management server 131 publishes the processed image in a state in which the image can be downloaded (S1105). If it is determined that the option of privacy protection is not enabled in step S1101 or if it is determined that another person other than the identified person to be photographed is not captured in step S1103, the image processing is not necessary so that an original image made downloadable (S1106).

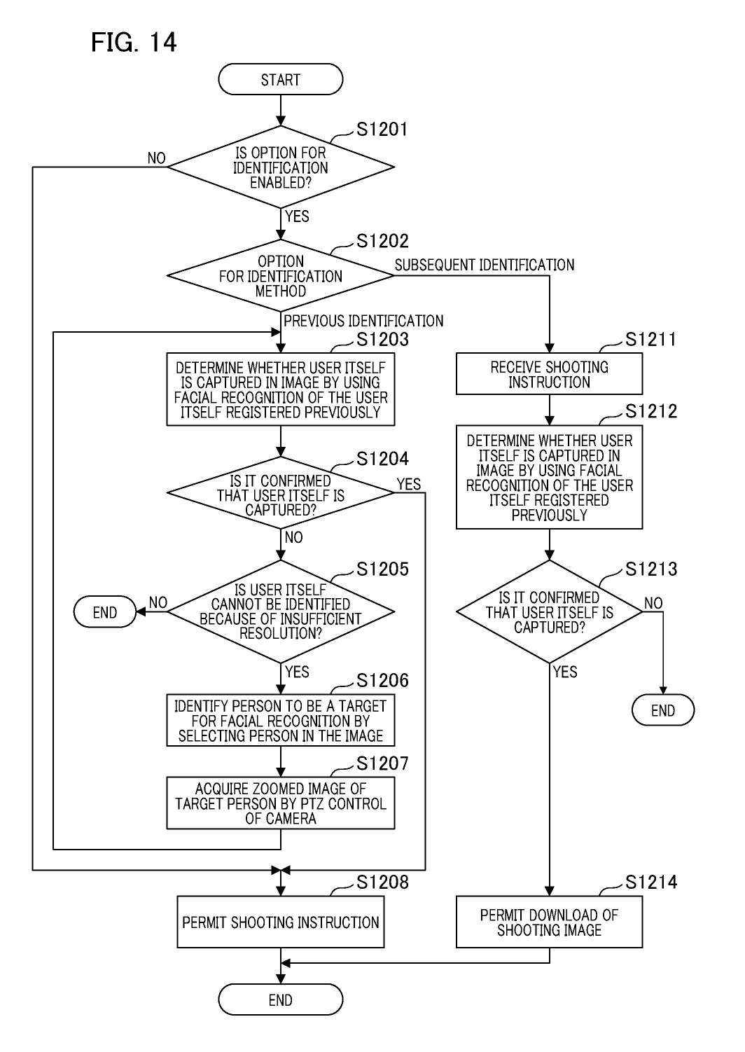

FIG. 14 is a flowchart illustrating a method for performing an option process of identification of a person at the time of shooting.

This process is provided for suppressing an occurrence of a situation such that a third person other than yourself is accidentally captured as a person to be photographed in the aforementioned option process of privacy protection, or a third person is surreptitiously photographed by taking a photograph of the third person as a person to be photographed.

When the application 301 of the client computer 111 accepts the input for shooting instruction in the aforementioned step S929 or S931, the client computer 111 determines whether the option for the identification of a person is enabled (S1201). If it is determined that the option of identification of a person is enabled, the application 301 determines an option for an identification method (S1202). If the option for an identification method is previous identification, the camera management server 131 performs facial recognition using a facial image of a user itself, which is previously registered with the camera management server 131, and confirms that the user itself is captured in the image (S1203).

The camera management server 131 determines whether or not it is confirmed that the user itself is captured in the image (S1204). If the user itself is not captured, the camera management server 131 determines whether or not a person can be confirmed in the image but the user itself could not be identified because of the insufficient resolution (S1205). If it is not the case that a person can be confirmed but the user itself could not be identified, the process finishes and the application 301 does not permit the shooting instruction in step S929 or S931.

In contrast, if a person can be confirmed in the image but the user itself could not be identified, the camera management server 131 make the application 301 of the client computer 111 display a screen 1010 (FIG. 12B). Then in the screen 1010, an input for selecting a person to be a target for facial recognition (in other words, the person to be photographed itself) is accepted (S1206).

The camera control server 122 controls the PTZ of the network camera 121 with respect to the location of the selected person, acquires a zoomed image of the person to be the target for facial recognition, and displays them in a window 1015 inside the screen 1010. Then, in the following, the identification of a person of step S1203 and step S1204 is performed again. In step S1204, if it is confirmed that the user itself is captured in the image, the shooting instruction in step S929 or S931 is permitted (S1208).

In contrast, in step S1202, if the option for an identification method is subsequent identification, the application 301 permits the shooting instruction in step S929 or S931 and the camera control server 122 receives the shooting instruction (S1211). Then, in step S934, when the camera management server 131 performs the image processing, a process that is as same as the process in step S1203 is performed. In other words, the camera management server 131 performs facial recognition using a facial image of a user itself, which has been previously registered with the camera management server 131, and confirms that the user itself is captured in the image (S1212).

The camera management server 131 determines whether or not it has been confirmed that the user itself has been captured in the image (S1213). If the user itself is not captured, the process finishes and downloading images is not permitted in the subsequent step. In contrast, if it is confirmed that the user itself has been captured, downloading images is permitted in the subsequent step and the images are able to store in the client computer 111 (S1214).

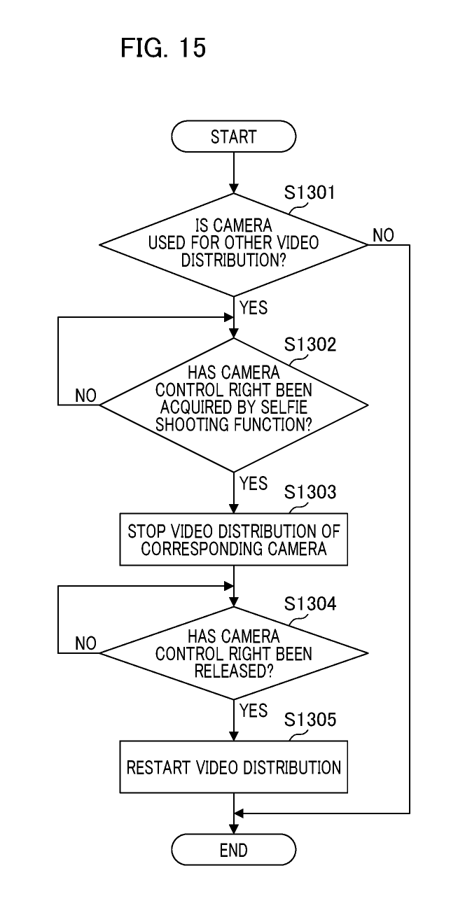

FIG. 15 is a flowchart illustrating a method for performing an option process for restricting a distribution of a video that is shot in the selfie shooting service if the network camera 121 that provides the selfie shooting service also serves as a network camera for other video distributions.

This process enables the network camera to provide the selfie shooting service if there is a request from a user while the network camera is usually distributing a video of, for example, a scenery or the like as a weather camera or a webcast camera.

Firstly, the camera management server 131 determines whether or not the network camera 121 serves as a camera for another usage other than the selfie shooting service, for example, a camera for a video distribution, or the like (S1301). If the network camera 121 serves as a camera for another usage, the camera management server 131 determines whether the camera control right for the network camera 121 has been acquired for the selfie shooting service, in the aforementioned step S915 and S916 (S1302).

If the camera control right has been acquired for the selfie shooting service, the video distribution of the corresponding camera is stopped, and functions and videos of the corresponding camera are provided only to the user of the selfie shooting service (S1303). The camera management server 131 determines whether the control right for the network camera 121 has been released in the aforementioned step S941 and S942 (S1304). If the camera control right has been released, the video distribution is restarted again (S1305).

As described above, according to the present embodiment, due to the use of a beacon transmitting and receiving function and a push notification function of the client computer, the following can be performed: Deciding a camera that is able to shoot, notifying a user that the camera is ready to use, setting a shooting frame by PTZ control, and the like can be performed automatically.

Accordingly, shooting by using a network camera from a client computer such as a mobile terminal can be easily performed by a simple procedure. In addition, privacy protection for a person other than a person to be photographed can be provided so that consideration may be given to operation in an open space such as outdoors or parks.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-092940, filed May 6, 2016, which is hereby incorporated by reference wherein in its entirety.

What is claimed is:

1. A network system that comprises a camera provided at a predetermined shooting point, a camera system for providing a shooting service by the camera, and an information processing apparatus carried by a user, the system comprising:
a notification unit configured to provide a notification of a confirmation for shooting to the information processing apparatus detected in a shooting area of the camera in accordance with a movement of the user;
a control unit configured to control a camera control right;
an instruction unit configured to input an instruction for an operation of the camera on the information processing apparatus in accordance with an acquisition of the camera control right; and
a providing unit configured to provide an image shot by the camera following the inputted instruction to the information processing apparatus through the camera system.

2. The network system according to claim 1,
wherein the information processing apparatus comprises a transmitting unit configured to transmit a location of the information processing apparatus to the camera system, and
wherein the camera system comprises a setting unit configured to set a direction and a zoom of the camera according to the location of the information processing apparatus which is transmitted by the transmitting system.

3. The network system according to claim 2, wherein the transmitting unit receives a signal from a location information transmitter and transmits the location of the information processing apparatus, which is based on the received information, to the camera system.

4. The network system according to claim 1, wherein the camera system acquires, by the control unit, the camera control right for each information processing apparatus in order to realize the operation of the camera that follows the user's instruction, and releases, by the control unit, the camera control right if the information processing apparatus finishes the use of the camera.

5. The network system according to claim 4, wherein in case where the camera is used for a video distribution other than the shooting service and the control unit acquires the camera control right for the shooting service, the control unit stops the video distribution and restarts the video distribution if the camera control right is released.

6. The network system according to claim 1,
wherein the camera system comprises a processing unit configured to perform, if there is a person other than a person to be photographed included in the shot image by the camera, a process that erases the person from the shot image,
wherein the camera system provides, by the providing unit, the shooting image processed by the processing unit to the information processing apparatus.

7. The network system according to claim 1, wherein the camera system comprises a confirmation unit configured to confirm whether or not a person included in the shot image by the camera is a person to be photographed, which has been previously registered.

8. A method for controlling a network system that comprises a camera provided at a predetermined shooting point, a camera system for providing a shooting service by the camera, and an information processing apparatus carried by a user, the method comprising:
providing a notification of a confirmation for shooting to the information processing apparatus detected in a shooting area of the camera in accordance with a movement of the user;
controlling a camera control right;
inputting an instruction for an operation of the camera on the information processing apparatus in accordance with an acquisition of the camera control right; and providing an image shot by the camera following the inputted instruction to the information processing apparatus through the camera system.
